(19) United States
(12) Patent Application Publication
(10) Pub. No.: US 2025/0175760 A1
(43) Pub. Date: May 29, 2025

(54) NETWORK MANAGEMENT DEVICE COMPRISING PLURALITY OF EXTERNAL ELECTRONIC DEVICES, AND METHOD THEREFOR

(71) Applicant: Samsung Electronics Co., Ltd., Suwon-si (KR)

(72) Inventors: Kwanghoon HAN, Suwon-si (KR); Dawoon JUNG, Suwon-si (KR)

(21) Appl. No.: 19/040,367

(22) Filed: Jan. 29, 2025

Related U.S. Application Data
(63) Continuation of application No. PCT/KR2023/009086, filed on Jun. 29, 2023.

(30) Foreign Application Priority Data
Aug. 17, 2022 (KR) 10-2022-0102530
Oct. 24, 2022 (KR) 10-2022-0137565

(51) Int. Cl. H04W 4/02; G01S 5/02; H04W 64/00

(52) U.S. Cl. CPC H04W 4/023; G01S 5/0242; H04W 64/00

(57) ABSTRACT

An electronic device, according to various embodiments, comprises a wireless communication circuit, a memory, and at least one processor, comprising processing circuitry, operatively connected to the wireless communication circuit and the memory. The memory stores instructions for generating management information for managing a plurality of anchors, and at least one processor, individually and/or collectively, is configured to execute the instructions and to: confirm control scheduling for the plurality of anchors; control transmission of ranging signals by the plurality of anchors to be sequentially performed by the wireless communication circuit based on the control scheduling; receive, from the plurality of anchors, feedback signals according to the transmission of the ranging signals; and update the topology for the plurality of anchors based on the feedback signals.

### CROSS-REFERENCE TO RELATED APPLICATIONS

This application is a continuation of International Application No. PCT/KR2023/009086 designating the United States, filed on Jun. 29, 2023, in the Korean Intellectual Property Receiving Office and claiming priority to Korean Patent Application Nos. 10-2022-0102530, filed on Aug. 17, 2022, and 10-2022-0137565, filed on Oct. 24, 2022, in the Korean Intellectual Property Office, the disclosures of each of which are incorporated by reference herein in their entireties.

### BACKGROUND

### Field

The disclosure relates to a network management device including a plurality of external electronic devices, and a method thereof.

### Description of Related Art

With the development of technology, a demand for providing various information simultaneously using various technologies and electronic devices is increasing. For example, an electronic device may perform location (or distance, angle) measurement using a plurality of external electronic devices. To this end, the plurality of external electronic devices may provide positioning services through ranging by configuring a network that performs mutual communication based on wireless communication such as ultra-wideband (UWB) communication.

An electronic device may manage a positioning system network including a plurality of external electronic devices, based on information acquired from the plurality of external electronic devices.

### SUMMARY

An electronic device according to various example embodiments of the disclosure may include: a wireless communication circuit, memory, and at least one processor, comprising processing circuitry, operatively connected to the wireless communication circuit and the memory, wherein the memory storing instructions which, when executed by at least one processor individually and/or collectively, cause the electronic device to: generate management information for managing a plurality of anchors, identify control scheduling for the plurality of anchors, control transmission of ranging signals by the plurality of anchors to be sequentially performed through the wireless communication circuit based on the control scheduling, receive, from the plurality of anchors, feedback signals according to the ranging signal transmission, and update the topology for the plurality of anchors based on the feedback signals.

A method performed by an electronic device according to various example embodiments may include: identifying a control scheduling for a plurality of anchors to generate management information for managing the plurality of anchors, controlling a ranging signal transmission by the plurality of anchors to be performed respectively through the wireless communication circuit based on the control scheduling, receiving, from the plurality of anchors, a feedback signal according to the ranging signal transmission, and updating a topology for the plurality of anchors based on the feedback signal.

According to various example embodiments, an electronic device may acquire information by controlling external electronic devices included in a positioning system network including a plurality of external electronic devices and manage the network based on the information.

The effects that may be obtained in the disclosure are not limited to the technical effects mentioned above, and other effects not mentioned may be clearly understood by those of ordinary skill in the art to which the disclosure belongs from the following description.

### BRIEF DESCRIPTION OF THE DRAWINGS

With respect to the description of the drawing, the same or similar reference numerals may be used for identical or similar components. Further, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example of a network including a plurality of external electronic devices according to various embodiments;

FIG. 3 is a block diagram illustrating an example configuration of an electronic device according to various embodiments;

FIG. 4 is a block diagram is a block diagram illustrating an example configuration of an external electronic device according to various embodiments;

FIG. 5 is a diagram illustrating example control of an electronic device for a plurality of external electronic devices according to various embodiments;

FIG. 6 is a flowchart illustrating example network management including a plurality of external electronic devices by an electronic device according to various embodiments;

FIG. 7 is a diagram illustrating an example control operation for managing a cluster including a plurality of external electronic devices by an electronic device according to various embodiments;

FIG. 8 is a flowchart illustrating an example control operation for managing a network including a plurality of external electronic devices by an electronic device according to various embodiments;

FIG. 9 is a signal flow diagram illustrating an example control operation for managing a network including a plurality of external electronic devices by an electronic device according to various embodiments;

FIG. 10 is a flowchart illustrating an example control operation for managing a network including a plurality of external electronic devices by an electronic device according to various embodiments; and

FIG. 11 is a signal flow diagram illustrating an example control operation for managing a network including a plurality of external electronic devices by an electronic device according to various embodiments.

### DETAILED DESCRIPTION

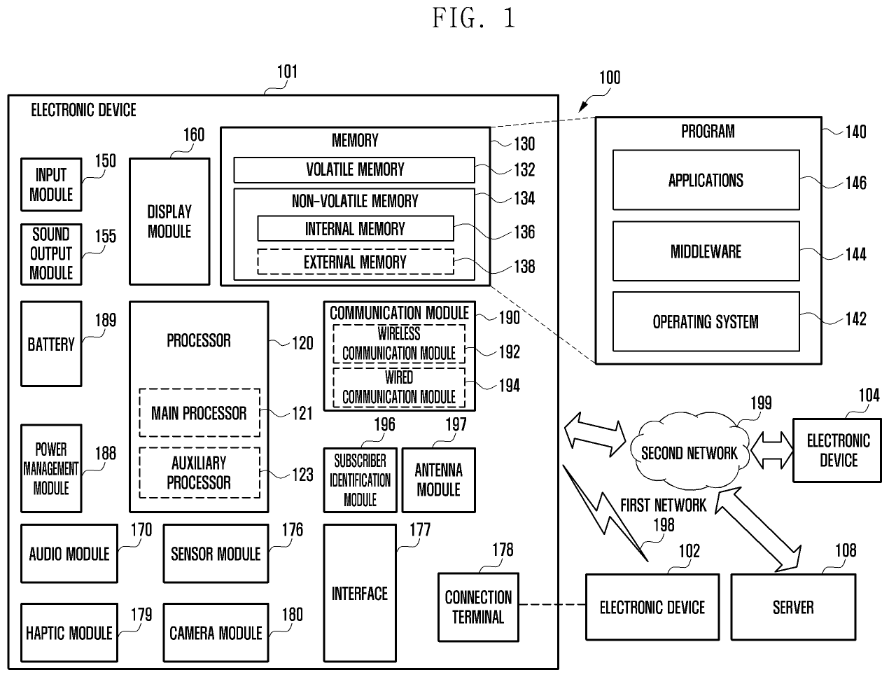

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™M, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

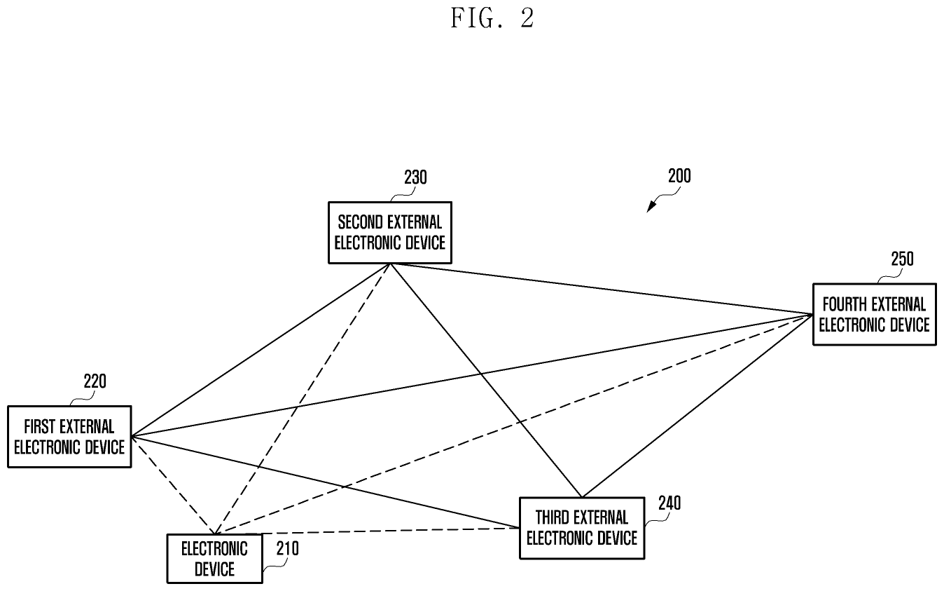

FIG. 2 is a diagram 200 illustrating an example of a network including a plurality of external electronic devices according to various embodiments.

Referring to FIG. 2, a first external electronic device 220, a second external

electronic device 230, a third external electronic device 240, and/or a fourth external electronic device 250 may configure a cluster. For example, a plurality of external electronic devices may periodically transmit and receive signals to and from each other to provide a positioning service, and accordingly, may be referred to as a communicatively connected cluster. The plurality of external electronic devices in the cluster may include an initiator triggering packet exchange and one or more responders transmitting a response signal in response to the trigger. The plurality of external electronic devices may be installed at a specified interval from each other in consideration of the signal reach distance (e.g., 10 to 20 m in the case of UWB).

According to various embodiments, a plurality of external electronic devices may perform ranging in units of clusters. Therefore, a cluster may be configured based on topology information of the plurality of external electronic devices and a positioning service may be provided in units of the configured cluster.

The plurality of external electronic devices 220, 230, 240, and/or 250 may configure a positioning system (e.g., real time locating system (RTLS)) and provide a positioning service so that an arbitrary electronic device (not illustrated) may calculate a location (distance or direction) using, for example, UWB-based downlink time difference of arrival (DL-TDoA)-based ranging. For example, the arbitrary electronic device (not illustrated) may calculate a time difference of arrival (TDoA) between an arbitrary electronic device (not illustrated) and two or more external electronic devices after compensating for a clock drift between the arbitrary electronic device (not illustrated) and the plurality of external electronic devices based on a response time included in a signal from two or more external electronic devices, and measure the location of the arbitrary electronic device (not illustrated) based on the calculated arrival time difference based on the locations of the plurality of external electronic devices.

When entering a cluster, an arbitrary electronic device (not illustrated) may receive packet signals transmitted or received between two or more external electronic devices (e.g., the first external electronic device 220, the second external electronic device 230, the third external electronic device 240, and/or the fourth external electronic device 250), and measure its own location using the difference in arrival time of the received signals.

As described above, for measuring the location (distance or direction) of the arbitrary electronic device (not illustrated), a plurality of external electronic devices (e.g., the second external electronic device 230, the third external electronic device 240, and/or the fourth external electronic device 250) configuring a cluster and communicating through a mesh network may be referred to as anchors.

In various embodiments, the electronic device 210 may function as a server that manages a cluster configured by a plurality of external electronic devices 220, 230, 240 and/or 250 as a network positioning system.

In various embodiments, the electronic device 210 may transmit a control signal for controlling various operations of the plurality of external electronic devices 220, 230, 240 and/or 250 and receive a response or feedback signal therefor from the plurality of external electronic devices 220, 230, 240 and/or 250.

In various embodiments, the electronic device 210 may preconfigure a scheduling for the time (or order) when at least one external electronic device 220, 230, 240, and/or 250 transmits a message (e.g., a poll message and/or a response message) within one ranging round.

According to various embodiments, the electronic device 210 may generate topology information of a plurality of external electronic devices 220, 230, 240 and/or 250 and provide a positioning service based on a cluster configured based on the topology information.

According to various embodiments, the electronic device 210 may transmit control signals for a plurality of external electronic devices 220, 230, 240 and/or 250 during a management period scheduled before or after the ranging round, as a period separate from the ranging round, and accordingly, may control the operations of the plurality of external electronic devices 220, 230, 240 and/or 250.

According to various embodiments, the electronic device 210 may transmit control signals for the plurality of external electronic devices 220, 230, 240 and/or 250 during the management period, thereby causing the plurality of external electronic devices 220, 230, 240 and/or 250 to sequentially transmit ranging signals according to the scheduling.

According to various embodiments, the plurality of external electronic devices 220, 230, 240 and/or 250 may sequentially transmit a signal (e.g., a ranging signal) according to a scheduling under the control of the electronic device 210 to collect various pieces of measurement information for generating topology information of a cluster configured by the plurality of external electronic devices 220, 230, 240 and/or 250.

According to various embodiments, the plurality of external electronic devices 220, 230, 240 and/or 250 may sequentially transmit signals (e.g., ranging signals) according to a schedule under the control of the electronic device 210, and in response thereto, receive signals from other external electronic devices 220, 230, 240 and/or 250, and acquire measurement information based on the signals.

According to various embodiments, the measurement information may include measurement values such as, for example, received signal strength indicator (RSSI), signal to noise ratio (SNR), and line-of-sight (LoS) measurement between external electronic devices.

According to various embodiments, the plurality of external electronic devices 220, 230, 240 and/or 250 may transmit acquired measurement information as a feedback signal to the electronic device 210.

According to various embodiments, the plurality of external electronic devices 220, 230, 240 and/or 250 may transmit the acquired measurement information to the electronic device 210 at the time of acquisition. For example, the plurality of external electronic devices 220, 230, 240 and/or 250 may transmit the acquired measurement information to the electronic device 210 even without a request from the electronic device 210.

According to various embodiments, the plurality of external electronic devices 220, 230, 240 and/or 250 may transmit the acquired measurement information to the electronic device 210 at the time when all of the acquisition of the measurement information by the plurality of external electronic devices 220, 230, 240 and/or 250 are completed. For example, the measurement information acquired by the plurality of external electronic devices 220, 230, 240 and/or 250 may be transmitted to the electronic device 210 in response to the request of the electronic device 210.

According to various embodiments, the electronic device 210 may generate topology information between the plurality of external electronic devices 220, 230, 240 and/or 250 or topology information configuring a cluster thereof based on the measurement information acquired from the plurality of external electronic devices 220, 230, 240 and/or 250.

According to various embodiments, the electronic device 210 may periodically update topology information of the cluster of the plurality of external electronic devices 220, 230, 240 and/or 250.

According to various embodiments, the electronic device 210 may acquire measurement information through the plurality of external electronic devices 220, 230, 240 and/or 250 during the management period in order to update topology information of the cluster of the plurality of external electronic devices 220, 230, 240 and/or 250.

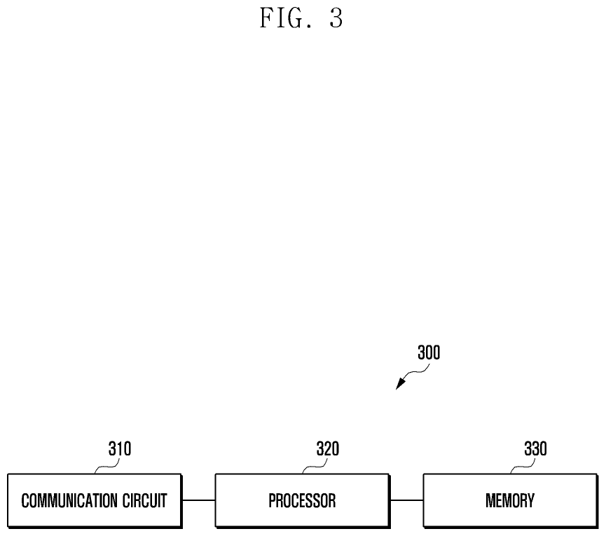

FIG. 3 is a block diagram illustrating an example configuration of an electronic device according to various embodiments.

Referring to FIG. 3, an electronic device 300 (e.g., the electronic device 210 of FIG. 2) may include a communication circuit (or communication circuitry) 310 (e.g., the communication module 190 of FIG. 1), a processor (e.g., including processing circuitry) 320 (e.g., the processor 120 of FIG. 1), and/or a memory 330 (e.g., the memory 130 of FIG. 1).

In various embodiments, the communication circuit 310 (e.g., the communication module 190 of FIG. 1) may support connection of the electronic device with at least one external electronic device (e.g., the first external electronic device 220, the second external electronic device 230, the third external electronic device 240, and/or the fourth external electronic device 250 of FIG. 2). The communication circuit 310 may include a short-range communication circuit, and the short-range communication circuit may include at least one of Bluetooth, Bluetooth low energy (BLE), ultra-wideband (UWB), and Wi-Fi.

In an embodiment, the electronic device 300 may communicate with a plurality of external electronic devices through UWB communication. The disclosure is not limited thereto, and the electronic device 300 may activate UWB communication using Wi-Fi, a UWB in-band discovery scheme, or an out-of-band.

In various embodiments, the memory 330 (e.g., the memory 130 of FIG. 1) may perform a function of storing a program (e.g., the program 140 of FIG. 1) for processing and controlling the processor 320 of the electronic device, an operating system (OS) (e.g., the operating system 142 of FIG. 1), various applications, and/or input/output data, and may store a program for controlling the overall operation of the electronic device 300. The memory 330 may store various configuration information necessary for processing functions related to various embodiments of the disclosure in the electronic device 300.

In an embodiment, the memory 330 may store measurement information of external electronic devices (e.g., the first external electronic device 220, the second external electronic device 230, the third external electronic device 240, and/or the fourth external electronic device 250).

In an embodiment, the memory 330 may store topology information generated based on the measurement information of the external electronic devices (e.g., the first external electronic device 220, the second external electronic device 230, the third external electronic device 240, and/or the fourth external electronic device 250).

In an embodiment, the memory 330 may store information necessary to generate a proximity graph based on the measurement information of the external electronic devices (e.g., the first external electronic device 220, the second external electronic device 230, the third external electronic device 240, and/or the fourth external electronic device 250).

In an embodiment, the memory 330 may store information necessary to generate topology information based on the proximity graph generated based on the measurement information of the external electronic devices (e.g., the first external electronic device 220, the second external electronic device 230, the third external electronic device 240, and/or the fourth external electronic device 250).

In various embodiments, the processor 320 (e.g., the processor 120 of FIG. 1) may include various processing circuitry, including, for example, a micro controller unit (MCU), and may control a plurality of hardware components connected to the processor 320 by driving an operating system (OS) or an embedded software program. The processor 320 may control a plurality of hardware components according to, for example, instructions (e.g., the program 140 of FIG. 1) stored in the memory 330. The processor 320 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, the processor 320 may transmit control signals for a plurality of external electronic devices 220, 230, 240 and/or 250 during a management period to acquire measurement information.

According to various embodiments, the processor 320 may cause a plurality of external electronic devices 220, 230, 240 and/or 250 to sequentially transmit ranging signals according to scheduling during the management period.

According to various embodiments, through a feedback, the processor 320 may acquire measurement information that acquired by the plurality of external electronic devices 220, 230, 240 and/or 250 by sequentially transmitting ranging signals according to scheduling under the control of the electronic device 210.

According to various embodiments, the processor 320 may generate a proximity graph based on the measurement information of external electronic devices (e.g., the first external electronic device 220, the second external electronic device 230, the third external electronic device 240, and/or the fourth external electronic device 250).

According to various embodiments, the processor 320 may generate topology information between external electronic devices (e.g., the first external electronic device 220, the second external electronic device 230, the third external electronic device 240, and/or the fourth external electronic device 250) based on the generated proximity graph.

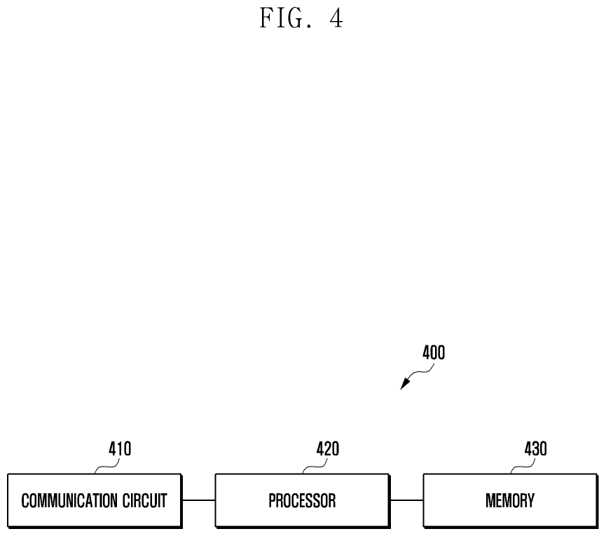

FIG. 4 is a block diagram illustrating an example configuration of an external electronic device according to various embodiments.

The external electronic device 400 illustrated in FIG. 4 according to various embodiments may be an external electronic device (e.g., the first external electronic device 220) of FIG. 2 described above. The external electronic device 400 is not limited to the first external electronic device 220, and may be another external electronic device (e.g., the second external electronic device 230, the third external electronic device 240, or the fourth external electronic device 250) of FIG. 2.

Referring to FIG. 4, the external electronic device 400 may include a communication circuit (or communication circuitry) 410 (e.g., the communication module 190 of FIG. 1), a processor (e.g., including processing circuitry) 420 (e.g., the processor 120 of FIG. 1), and/or a memory 430 (e.g., the memory 130 of FIG. 1).

In various embodiments, the communication circuit 410 (e.g., the communication module 190 of FIG. 1) may support connection of the electronic device with at least one external electronic device (e.g., the electronic device 210, the second external electronic device 230, the third external electronic device 240, and/or the fourth external electronic device 250 of FIG. 2). The communication circuit 410 may include a short-range communication circuit, and the short-range communication circuit may include at least one of Bluetooth, Bluetooth low energy (BLE), ultra-wideband (UWB), and Wi-Fi.

In an embodiment, the external electronic device 400 may control the activation of UWB communication using a low-power communication module such as a Bluetooth low energy (BLE). The disclosure is not limited thereto, and the external electronic device 400 may control the activation of UWB communication using Wi-Fi, a UWB in-band discovery scheme, or an out-of-band.

In various embodiments, the memory 430 (e.g., the memory 130 of FIG. 1) may perform a function of storing a program (e.g., the program 140 of FIG. 1) for processing and controlling the processor 420 of the external electronic device, an operating system (OS) (e.g., the operating system 142 of FIG. 1), various applications, and/or input/output data, and may store a program for controlling the overall operation of the external electronic device 400. The memory 430 may store various configuration information necessary for processing functions related to various embodiments of the disclosure in the external electronic device 400.

In an embodiment, the memory 430 may store time information of messages transmitted and received between external electronic devices (e.g., the first external electronic device 220, the second external electronic device 230, the third external electronic device 240, and/or the fourth external electronic device 250). The time information may include a reception time at which each external electronic device receives a message transmitted from another external electronic device, and/or a transmission time at which each external electronic device transmits a message, and/or a response time.

In various embodiments, the processor 420 (e.g., the processor 120 of FIG. 1) may include various processing circuitry, including, for example, a micro controller unit (MCU), and may control a plurality of hardware components connected to the processor 420 by driving an operating system (OS) or an embedded software program. The processor 420 may control a plurality of hardware components according to, for example, instructions (e.g., the program 140 of FIG. 1) stored in the memory 430. The processor 420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments, the processor 420 may store, in the memory 430, a time of transmitting a ranging signal for range measurement to another external electronic device (e.g., the external electronic device 230, 240 and/or 250) and a response time transmitted from another external electronic device (e.g., a response signal) to a ranging signal (e.g., a response signal) received in response to the transmitted ranging signal. For example, the response time may be calculated based on a time at which a signal transmitted from an external electronic device (e.g., the first external electronic device 220) is received by another external electronic device (e.g., the external electronic devices 230, 240 and/or 250) and a transmission time of a signal transmitted from another external electronic device (e.g., external electronic devices 230, 240 and/or 250).

In various embodiments, the first external electronic device 220, the second external electronic device 230, the third external electronic device 240, and/or the fourth external electronic device 240 of FIG. 2 may include a communication circuit, a memory, and/or a processor, similar to the external electronic device 400, and may operate similarly to the operation of the communication circuit 410, the memory 430, and/or the processor 420 of the external electronic device 400 described above.

According to various embodiments, a plurality of external electronic devices (e.g., the first external electronic device 220, the second external electronic device 230, the third external electronic device 240, and/or the fourth external electronic device 240) of FIG. 2 may compensate for a clock drift between a plurality of external electronic devices (e.g., the first external electronic device 220, the second external electronic device 230, the third external electronic device 240, and/or the fourth external electronic device 240) based on the transmission and reception times of the ranging signals that are mutually transmitted and received. An arbitrary electronic device (not illustrated) may calculate a time difference of arrival (TDoA) with a plurality of external electronic devices (e.g., the first external electronic device 220, the second external electronic device 230, the third external electronic device 240, and/or the fourth external electronic device 240) compensated for the clock drift, and based on the time difference of arrival, may measure the location of the arbitrary electronic device (not illustrated).

In various embodiments, in order to receive a response message from at least one other external electronic device, at least one external electronic device (e.g., first external electronic device 220, second external electronic device 230, third external electronic device 240, and/or fourth external electronic device 240) located in a cluster may activate (or turn on) a communication circuit (e.g., a UWB module) during a range measurement period. At least one external electronic device (e.g., the first external electronic device 220, the second external electronic device 230, the third external electronic device 240, and/or the fourth external electronic device 240) may activate (or turn on) the UWB module to receive a message broadcasted by at least one other external electronic device, or may receive a message transmitted and received in a unicast manner by the other external electronic devices by snipping.

In various embodiments, an arbitrary electronic device (not illustrated) may activate (or turn on) a communication circuit (e.g., a UWB module) during a range measurement period, and accordingly, and may receive a message broadcasted by a plurality of external electronic devices (e.g., the first external electronic device 220, the second external electronic device 230, the third external electronic device 240, and/or the fourth external electronic device 240) or a message transmitted and received in a unicast manner by snipping, and use the message to measure the location of any electronic device (not illustrated).

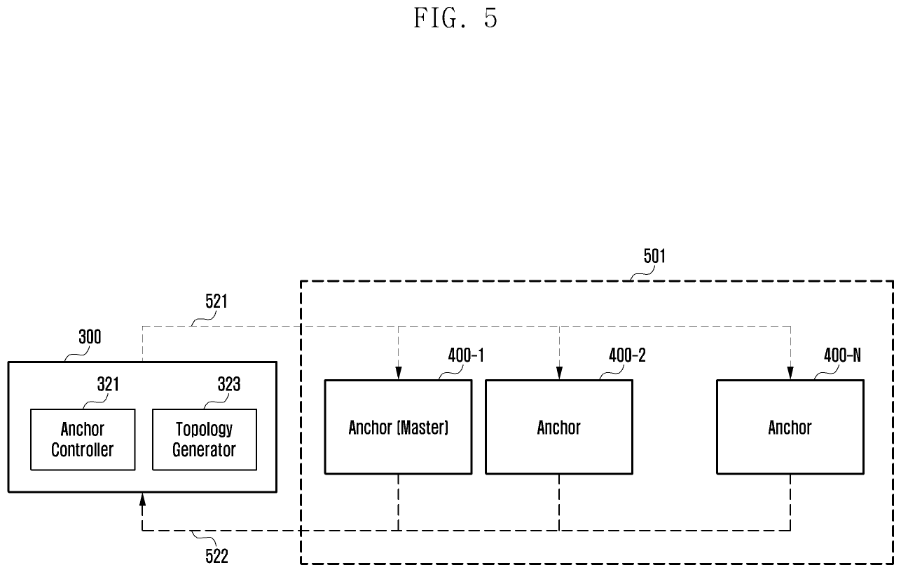

FIG. 5 is a diagram illustrating example control by an electronic device for a plurality of external electronic devices according to various embodiments.

Referring to FIG. 5, an electronic device (e.g., the electronic device 300 of FIG. 3) may configure a management system for managing a plurality of anchors 400-1, 400-2, . . . , 400-N (e.g., the external electronic device 400 of FIG. 4 or the first external electronic device 220 of FIG. 2, the second external electronic device 230, the third external electronic device 240, and/or the fourth external electronic device 240).

According to various embodiments, the electronic device 300 may configure a cluster 501 including a plurality of anchors 400-1, 400-2, . . . , and 400-N so that the cluster may function as a positioning system to provide a positioning service.

According to various embodiments, the electronic device 300 may transmit scheduling information to a plurality of anchors 400-1, 400-2, . . . , and 400-N through a control channel 521, so that the plurality of anchors 400-1, 400-2, . . . , and 400-N may acquire measurement information based on the scheduling information, for example, sequentially, by transmitting ranging signals. The control channel 521 may be configured using, for example, a wireless communication channel such as Wi-Fi or cellular communication.

According to various embodiments, the electronic device 300 may receive feedback on the measurement information acquired by the plurality of anchors 400-1, 400-2, . . . , and 400-N through a feedback channel 522. The feedback channel 522 may be configured using, for example, a wireless communication channel such as Wi-Fi or cellular communication.

According to various embodiments, the feedback through the feedback channel 522 by the plurality of anchors 400-1, 400-2, . . . , and 400-N may be performed separately at the time when each of the plurality of anchors 400-1, 400-2, . . . , and 400-N acquires the measurement information. For example, the plurality of anchors 400-1, 400-2, . . . , 400-N may transmit feedback on the measurement information acquired by each anchor at the end time of the allocated time slot. The feedback may not be performed in an in-band in which a ranging is performed, and in this case, a separate time allocation for the feedback may not be required.

According to various embodiments, the feedback through the feedback channel 522 by the plurality of anchors 400-1, 400-2, . . . , and 400-N may be performed at the time when all of the plurality of anchors 400-1, 400-2, . . . , and 400-N acquire the measurement information. For example, the measurement information measured by the plurality of anchors 400-1, 400-2, . . . , and 400-N may be packaged and transmitted to the electronic device 300 through the feedback channel 522. For example, after all the time slots allocated to the plurality of anchors 400-1, 400-2, . . . , 400-N are terminated, the measurement information acquired by each anchor may be packaged and transmitted to the electronic device 300 through the feedback channel 522. The feedback may not be performed in an in-band in which a ranging is performed, and in this case, a separate time allocation for the feedback may not be required.

According to various embodiments, the electronic device 300 may include an anchor controller 321 including various circuitry and/or executable program instructions that transmits scheduling information through the control channel 521 for anchor control, and a topology generator 323 including various circuitry and/or executable program instructions that generates topology information between anchors based on the measurement information received through the feedback channel 522.

According to various embodiments, an electronic device (e.g., the electronic device 210 of FIG. 2 or the electronic device 300 of FIG. 3 or FIG. 5) may include: a wireless communication circuit (e.g., the communication circuit 310 of FIG. 3), a memory (e.g., the memory 330 of FIG. 3), and at least one processor, comprising processing circuitry (e.g., the processor 320 of FIG. 3), operatively connected to the wireless communication circuit and the memory, wherein the memory storing instructions for generating management information for managing a plurality of anchors (e.g., external electronic devices 220, 230, 240 and/or 250 of FIG. 2, the external electronic device 400 of FIG. 4, or a plurality of anchors 400-1, 400-2, . . . , 400-N of FIG. 5), wherein the instructions which, when executed by at least one processor individually and/or collectively, cause the electronic device to: identify control scheduling for the plurality of anchors, control transmission of ranging signals by the plurality of anchors to be sequentially performed through the wireless communication circuit based on the control scheduling, receive, from the plurality of anchors, feedback signals according to the ranging signal transmission, and update the topology for the plurality of anchors based on the feedback signals.

According to various example embodiments, the instructions which, when executed by the at least one processor individually and/or collectively, cause the electronic device to receive each of the feedback signals according to the ranging signal transmission by each of the plurality of anchors.

According to various example embodiments, the instructions which, when executed by the at least one processor individually and/or collectively, cause the electronic device to: transmit the feedback request signal to the plurality of anchors based on the ranging signal transmission by the plurality of anchors being terminated, and receive the feedback signals of the plurality of anchors in response to the feedback request signal.

According to various example embodiments, the instructions which, when executed by the at least one processor individually and/or collectively, cause the electronic device to: trigger a management period for controlling the plurality of anchors according to the control scheduling, and control the ranging signal transmission by the plurality of anchors by transmitting a control signal to each of the plurality of anchors based on the control scheduling during the management period.

According to various example embodiments, the instructions which, when executed by the at least one processor individually and/or collectively, cause the electronic device to trigger the management period according to the control scheduling after termination of the normal operation period providing a positioning service by transmitting and receiving signals by the plurality of anchors.

According to various example embodiments, the instructions which, when executed by the at least one processor individually and/or collectively, cause the electronic device to update the topology for the plurality of anchors based on measurement information included in the feedback signal.

According to various example embodiments, the measurement information may include at least one of the received signal strength indicator (RSSI), signal to noise ratio (SNR), line-of-sight (LoS) measurement, or actual distance between the plurality of anchors.

According to various example embodiments, the instructions which, when executed by the at least one processor individually and/or collectively, cause the electronic device to generate a proximity graph between the plurality of anchors based on the measurement information.

According to various example embodiments, the proximity graph may be configured to be generated by combining a matrix having a line-of-sight (LoS) measurement between the plurality of anchors as an element and a matrix having at least one of the received signal strength indicator (RSSI), signal-to-noise ratio (SNR), or actual distance between the plurality of anchors as an element.

According to various example embodiments, the instructions which, when executed by the at least one processor individually and/or collectively, cause the electronic device to update the topology by connecting each vertex corresponding to the plurality of anchors with an edge based on an element of the proximity graph.

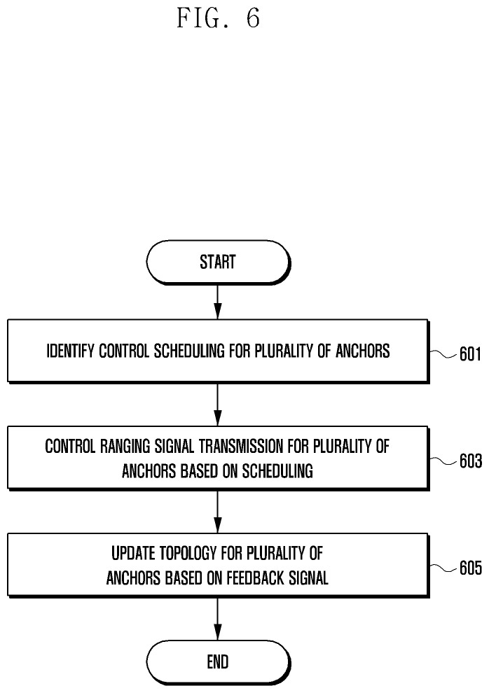

FIG. 6 is a flowchart illustrating an example network management including a plurality of external electronic devices (e.g., the external electronic devices 220, 230, 240 and/or 250 of FIG. 2, the external electronic device 400 of FIG. 4, or the plurality of anchors 400-1, 400-2, . . . , 400-N of FIG. 5) by an electronic device (e.g., the electronic device 210 of FIG. 2 or the electronic device 300 of FIG. 3 or FIG. 5) according to various embodiments.

According to various embodiments, the electronic device 300 may include a wireless communication circuit (e.g., the communication circuit 310 of FIG. 3), a memory (e.g., the memory 330 of FIG. 3), and a processor (e.g., the processor 320 of FIG. 3) operatively connected to the memory. The memory may store instructions for generating management information for managing a plurality of anchors. For example, the memory may store various data for generating topology information between a plurality of anchors. For example, the memory may store control scheduling information that defines a schedule for transmitting ranging signals for acquiring measurement information of the plurality of anchors.

According to various embodiments, in operation 601, the processor of the electronic device may identify control scheduling for a plurality of anchors.

According to various embodiments, in operation 603, the processor may schedule a management frame for the plurality of anchors through the wireless communication circuit based on the identified scheduling information. For example, the processor may control the ranging signal transmission by the plurality of anchors to be performed sequentially.

In various embodiments, the processor may transmit a control signal including scheduling information for operations of a plurality of anchors during a management period, so that the plurality of anchors may sequentially transmit ranging signals and acquire measurement information based on the scheduling information.

According to various embodiments, in operation 605, the processor may receive a feedback signal according to the ranging signal transmission from the plurality of anchors, and perform a topology update for the plurality of anchors based on the feedback signal.

According to various embodiments, the processor may receive feedback on measurement information acquired by the plurality of anchors.

According to various embodiments, the measurement information feedback by the plurality of anchors may be separately received at a time when each of the anchors acquires the measurement information.

According to various embodiments, the measurement information feedback by the plurality of anchors may be performed at a time when all of the plurality of anchors acquire the measurement information. For example, the electronic device may request the measurement information feedback from the plurality of anchors, and based on this, each of the plurality of anchors may transmit the acquired measurement information to the electronic device.

According to various embodiments, the processor may generate topology information between the plurality of anchors based on the feedback signal, and may cause the plurality of anchors to configure a cluster structure based on the topology information.

According to various embodiments, the processor may generate a proximity graph based on measurement information of the plurality of anchors.

According to various embodiments, the processor may generate topology information between the plurality of anchors based on the generated proximity graph, and update the cluster structure of the plurality of anchors based on the generated proximity graph.

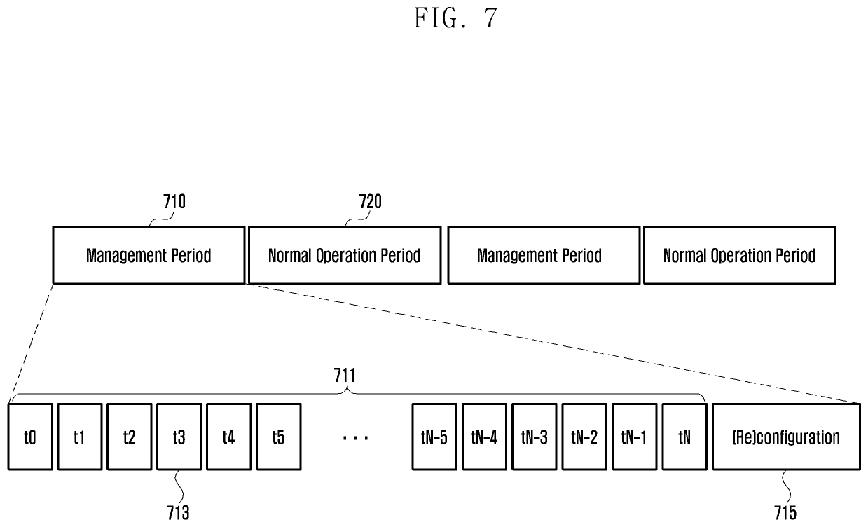

FIG. 7 is a diagram illustrating an example control operation for managing a network including a plurality of external electronic devices (also referred to as anchors) by an electronic device according to various embodiments.

Referring to FIG. 7, an electronic device (e.g., the electronic device 300 of

FIG. 3) may control a management system for managing a plurality of anchors (e.g., anchors 400-1, 400-2, . . . , 400-N of FIG. 5).

According to various embodiments, the electronic device 300 may generate topology information for the configuration of a cluster (e.g., the cluster 501 of FIG. 5) including a plurality of anchors and update topology information between the plurality of anchors based thereon, so that the cluster may function as a positioning system to provide a positioning service.

According to various embodiments, a processor may control anchors included in the cluster to perform scheduling so that measurement information necessary for generating topology information may be collected.

In various embodiments, the anchor management operation of the processor may be performed in a management period 710 rather than a normal operation period 720 in which a general positioning service is provided. The normal operation period 720 in which the general positioning service is provided may refer, for example, to a period in which a ranging operation is performed to identify the location (distance or direction) of an arbitrary electronic device (not illustrated) and, based on this, an RTLS is performed.

In various embodiments, according to anchor management scheduling, the management period 710 may include a ranging signal transmission period 711, a feedback period (not illustrated) for measurement information (e.g., RSSI, SNR, LoS Measure) measured according to the ranging signal reception, and a configuration (or reconfiguration) period 715.

According to various embodiments, the processor may control the UWB DL-TDoA Ranging signal to be transmitted sequentially by allocating time slots 713 for ranging signal transmission to each of all anchors in the cluster in the ranging signal transmission period 711, based on the management scheduling information.

According to various embodiments, the management operation of the processor in the management period 710 may be performed in a time domain in which a general positioning service is not performed. For example, the management operation of the processor may be performed within the management period 710 because the management period 710 is generated as the management operation is triggered periodically or according to a specified schedule during the period in which the RTLS is performed.

According to various embodiments, the processor may transmit scheduling information to a plurality of anchors through a control channel, and the plurality of anchors may sequentially transmit ranging signals based on the scheduling information to acquire measurement information.

According to various embodiments, the processor may receive feedback on the measurement information acquired by a plurality of anchors.

According to various embodiments, the feedback by a plurality of anchors may be separately performed at a time when each of the plurality of anchors acquires measurement information. For example, the feedback on the measurement information acquired by each anchor may be transmitted within a time slot 713 allocated to each of the plurality of anchors.

According to various embodiments, the feedback by a plurality of anchors may be performed at a time when all of the plurality of anchors acquire measurement information. For example, the measurement information measured by the plurality of anchors may be packaged and transmitted to the processor after the ranging signal transmission period 711 ends.

According to various embodiments, the processor may generate topology information based on the management scheduling information, based on the feedback on the measurement information acquired according to the sequential transmission and reception of the ranging signal performed by a plurality of anchors in the ranging signal transmission period 711.

According to various embodiments, the processor may generate a proximity graph between a plurality of anchors based on the measurement information acquired by the plurality of anchors during the configuration (or reconfiguration) period 715, and, based on this, may generate topology information between the plurality of anchors.

According to various embodiments, a proximity graph G may be expressed by the following Equation 1.

$$G = [ \begin{matrix}{g}_{11} & … & {g}_{1 N} \\ ⋮ & ⋱ & ⋮ \\ {g}_{N 1} & … & {g}_{NN}\end{matrix} ] \qquad [ Equation 1 ]$$

N is the total number of anchors, and for example, gᵢⱼ is a value that quantifies the proximity relationship between anchor i and anchor j. For example, the value of gᵢⱼ may be generated based on a value such as 1) RSSI, 2) SNR, 3) Line of Sight (LoS) Measure, 4) Physical distance.

According to various embodiments, in the proximity graph of a plurality of anchors, in addition to information reflecting the distance between anchors, such as RSSI, SNR, or actual distance value that may express the magnitude of the signal received by anchor i from anchor j, it is possible to acquire a numerical value of whether a straight-line distance between anchors may be secured by utilizing the line-of-sight measurement (LoS Measure). The LoS Measure may be calculated in various ways according to the known technology.

According to various embodiments, the proximity graph may be generated using three separate matrices, for example, G_{RSSI}, G_{SNR}, or G_{LoS}, based on values of RSSI, SNR, or LoS Measure, respectively.

According to various embodiments, the processor may generate a proximity graph by combining the proximity relationships between each anchor.

According to various embodiments, the processor may generate a proximity graph by controlling each anchor to collect measurement information including the proximity relationship gᵢⱼ values between each anchor.

According to various embodiments, the processor may perform scheduling so that the proximity relationship values between each anchor and other anchors may be measured, and receive proximity relationship values between each anchor at a time point designated for feedback and combine the values to generate a proximity graph.

According to various embodiments, the processor may generate three matrices G_{RSSI}, G_{LoS}, and G_{SNR} configuring a proximity graph using various pieces of measurement information measured by each anchor, for example, received signal strength (RSSI), LoS Measure, and SNR as elements.

According to various embodiments, the processor may identify a combination of anchors capable of securing LoS, and identify whether the combination of identified anchors exists at an appropriate distance to configure the cluster.

According to various embodiments, the processor may use Gₗₒₛ to identify a combination of anchors capable of securing LoS. For example, LoS Measure may be determined to be 0 or 1. For example, when the LoS Measure is measured with a value between 0 and 1, a step function may be applied to the LoS Measure to process Gₗₒₛ into an integer matrix.

Equation 2 below may represent an equation for transforming LoS Measure into an integer value.

$$s ( x ) = \{ \begin{matrix}1 , if x \geq th \\ 0 , if x < th\end{matrix} \qquad [ Equation 2 ]$$

The s( ) is a step function, the th is a threshold value for replacing the gᵢⱼ value with an integer, and may be a design parameter according to an algorithm. Accordingly, when a matrix is input into function s(x), a step function may be applied to each element of the matrix and a matrix of the same size may be output.

According to various embodiments, the G_{LoS_S} matrix may be output by applying a step function to the Gₗₒₛ matrix. Accordingly, topology information for cluster configuration may be quickly generated using the G_{LoS_S} matrix.

The following Equation 3 may represent a G_{LoS} matrix, and Equation 4 may represent a G_{LoS_S} matrix.

$${G}_{los} = [ \begin{matrix}{g}_{11} & … & {g}_{1 N} \\ ⋮ & ⋱ & ⋮ \\ {g}_{N 1} & … & {g}_{NN}\end{matrix} ] \qquad [ Equation 3 ]$$

$${G}_{los - s} = s ( {G}_{los} ) = [ \begin{matrix}s ( {g}_{11} ) & … & s ( {g}_{1 N} ) \\ ⋮ & ⋱ & ⋮ \\ s ( {g}_{N 1} ) & … & s ( {g}_{NN} )\end{matrix} ] \qquad [ Equation 4 ]$$

Here, gᵢⱼ may represent a LoS relationship value between anchors i and j.

According to various embodiments, the processor may determine whether to configure the same cluster according to a distance between two anchors having a LoS relationship. If the distance between anchors is relatively too far, it may not be suitable for configuring the same cluster.

According to various embodiments, the processor may utilize RSSI, SNR, or actual distance to indicate distance information between two anchors having a LoS relationship. A proximity matrix including relationship values based on RSSI values between anchors may be represented as G_{RSSI}. A proximity matrix including relationship values based on SNR values between anchors may be represented as G_{SNR}. A proximity matrix including relationship values based on actual distance values between anchors may be represented as G_{Dist}.

According to various embodiments, a step function may be applied to each of the matrices G_{RSSI}, G_{SNR}, or G_{Dist} so as not to configure the same cluster for a specific distance or more.

According to various embodiments, the matrix Gᵣₛₛᵢ representing the RSSI measurement value between anchors i and j may be represented by following Equation 5.

$${G}_{rssi} = [ \begin{matrix}{g}_{11} & … & {g}_{1 N} \\ ⋮ & ⋱ & ⋮ \\ {g}_{N 1} & … & {g}_{NN}\end{matrix} ] \qquad [ Equation 5 ]$$

According to various embodiments, the matrix Gᵣₛₛᵢ may be integerized by Equation 6 below using the step function s(x).

$${G}_{rssi - s} = s ( {G}_{rssi} ) = [ \begin{matrix}s ( {g}_{11} ) & … & s ( {g}_{1 N} ) \\ ⋮ & ⋱ & ⋮ \\ s ( {g}_{N 1} ) & … & s ( {g}_{NN} )\end{matrix} ] \qquad [ Equation 6 ]$$

According to various embodiments, by combining the LoS value with G_{RSSI}, G_{SNR}, or G_{Dist} (e.g., elementwise multiplication), a pair of anchors that are within a specific distance and secure LoS may be found.

According to various embodiments, a proximity graph representing the proximity values of pairs of anchors may be generated using G_{LoS} values and G_{RSSI} values. For example, Equation 7 below may represent an example of a proximity graph (matrix of RSSI & LoS) between anchors generated by the element-by-element product of G_{LoS} values and G_{RSSI} values.

$${G}_{rl - s} = {G}_{los - {s}^{.}} * {G}_{rssi - s} = [ \begin{matrix}{g}_{los - 11} * {g}_{rssi - 11} & … & {g}_{los - 1 N} * {g}_{rssi - 1 N} \\ ⋮ & ⋱ & ⋮ \\ {g}_{los - N 1} * {g}_{rssi - N 1} & … & {g}_{los - NN} * {g}_{rssi - NN}\end{matrix} ] \qquad [ Equation 7 ]$$

Here, * may represent the elementwise multiplication of two matrices with the same dimension.

According to various embodiments, the topology information may be simplified by transforming the distance into a hop count. Although actual links may not be configured between anchors, a result similar to the hop count may be derived by quantizing the measurement information. For example, the network topology may be divided into, for example, 4 hops using the quantize function q(x). In this case, q(x) may be defined as following Equation 8.

$$q ( x ) = \{ \begin{matrix}1 , if & 0 < x \leq {th}_{dist 1} \\ 2 , if & {th}_{dist 1} < x \leq {th}_{dist 2} \\ 3 , if & {th}_{dist 2} < x \leq {th}_{dist 3} \\ 4 , x = 0 & or others\end{matrix} \qquad [ Equation 8 ]$$

According to various embodiments, the proximity graph may represent network topology information reflecting a hop count using a quantize function. An example of the proximity graph reflecting the hop count may be represented by following Equation 9.

$${G}_{hop} = q ( {G}_{rssi - s} ) = [ \begin{matrix}q ( {g}_{11} ) & … & q ( {g}_{1 N} ) \\ ⋮ & ⋱ & ⋮ \\ q ( {g}_{N 1} ) & … & q ( {g}_{NN} )\end{matrix} ] \qquad [ Equation 9 ]$$

According to various embodiments, as examples of generated proximity graphs, matrices G_{LoS_S}, G_{RSSI_S}, G_{RL_S}, and G_{Hop} may be used as data for configuring clusters depending on the situation. Hereinafter, the proximity graph may be represented as G.

According to various embodiments, as an example of a cluster configuration, the cluster may be configured with m-coloring. For example, in order to use the same time slot between two separate clusters, there must be no interference with each other, and the timing schedule between clusters considering these conditions may be expressed in following Equation 10.

$$G = ( V , E ) \qquad [ Equation 10 ]$$

Here, n vertices V={1, . . . , n} may be connected by an edge E⊂V×V. For example, each vertex corresponding to a plurality of anchors may be connected by an edge based on the elements of the proximity graph. For example, the edge may be configured by a combination of the values of the proximity graphs of the anchors configuring each cluster. For example, if the sum of all proximity graph values of anchors configuring two clusters is not 0, the edge may be expressed as connected (e.g., a value of 1). Conversely, if the sum of all the proximity graph values is 0, the edge may be expressed as disconnected (e.g., a value of 0).

According to various embodiments, information such as m colors that may be allocated to each vertex corresponding to a plurality of clusters according to the m-coloring of the graph G may be allocated by the function of Equation 11 below.

$$c : V ↦ K := \{ 1 , … , m \} , c ( i ) \neq c ( j ) for all \{ i , j \} ∈ E \qquad [ Equation 11 ]$$

According to various embodiments, the processor may transmit topology information between a plurality of anchors to the plurality of anchors to configure or reconfigure the cluster of the plurality of anchors.

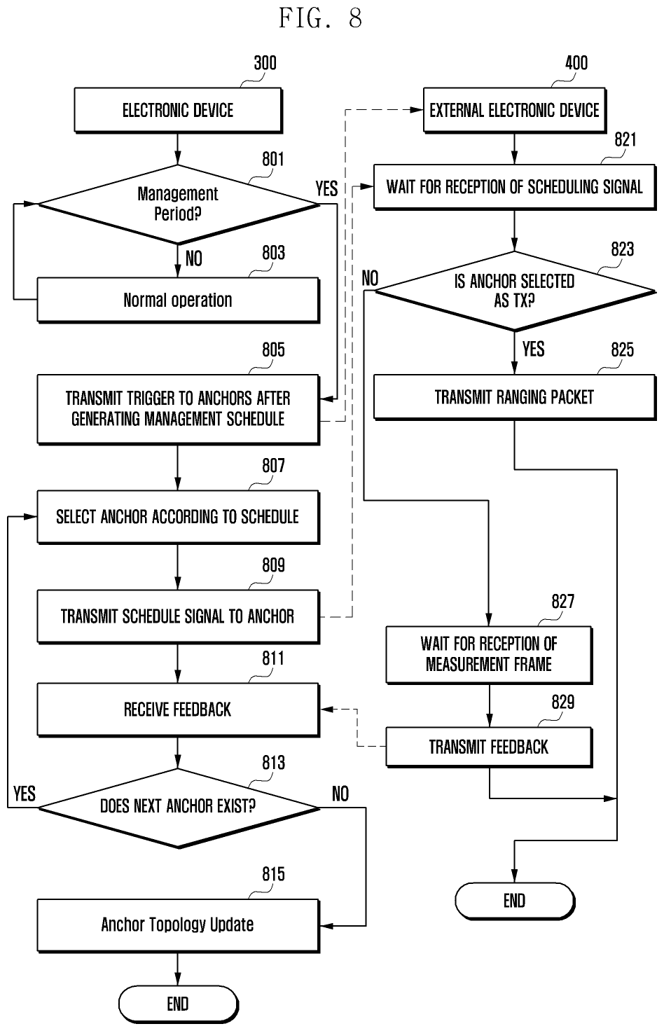

FIG. 8 is a flowchart illustrating an example control operation for managing a network including a plurality of external electronic devices by an electronic device according to various embodiments.

FIG. 8 is a flowchart illustrating a management of a network including a plurality of external electronic devices (e.g., external electronic devices 220, 230, 240 and/or 250 of FIG. 2, the external electronic device 400 of FIG. 4, or a plurality of anchors 400-1, 400-2, . . . , 400-N of FIG. 5) by an electronic device (e.g., the electronic device 210 of FIG. 2 or the electronic device 300 of FIG. 3 or FIG. 5) according to various embodiments.

According to various embodiments, in operation 801, the electronic device 300 may identify whether a management period has arrived. The management period may be configured periodically in advance or triggered when necessary by the electronic device 300.

According to various embodiments, if it is identified that the management period has not arrived, the electronic device 300 may proceed to operation 803 and control a plurality of external electronic devices to provide a positioning service according to a normal operation in the normal operation period.

According to various embodiments, if it is identified that the management period has arrived, the electronic device 300 may proceed to operation 805 to generate management schedule information and transmit a trigger of the management period to a plurality of external electronic devices.

According to various embodiments, when the management period is triggered, the electronic device 300 may select one of a plurality of external electronic devices according to the control scheduling information in operation 807. According to various embodiments, the electronic device 300 may transmit a scheduling signal including schedule information for control to one external electronic device selected in operation 809.

According to various embodiments, in operation 821, the external electronic device 400 that has received the trigger for the management period according to operation 805 from the electronic device 300 may wait for reception of a scheduling signal from the electronic device 300.

According to various embodiments, in operation 823, the external electronic device 400 may receive the scheduling signal and identify whether the external electronic device 400 is the anchor selected as the transmission device.

According to various embodiments, in operation 825, the external electronic device 400 may transmit a ranging packet signal when it is identified that the external electronic device 400 is the anchor selected as the transmission device.

According to various embodiments, when it is identified that the external electronic device 400 is not the anchor selected as the transmission device, the external electronic device 400 may proceed to operation 827, and receive a ranging packet signal transmitted from another external electronic device and receive a measurement frame including measurement information.

According to various embodiments, in operation 829, the external electronic device 400 may transmit a feedback signal including the acquired measurement information to the electronic device 300.

According to various embodiments, in operation 811, the electronic device 300 may receive a feedback signal transmitted from the external electronic device 400. According to an embodiment, the electronic device 300 may receive the feedback signal transmitted from the external electronic device 400 within a specified time. For example, if the feedback signal is not received from the external electronic device 400 within the specified time, the electronic device 300 may stop waiting for reception of the feedback signal from the external electronic device 400.

According to various embodiments, in operation 813, the electronic device 300 may identify whether an external electronic device of the next order exists based on the control scheduling information. According to various embodiments, if an external electronic device of the next order exists based on the control scheduling information, the electronic device 300 may return to operation 807 and repeat the above-described operations. According to various embodiments, if there is no external electronic device of the next order based on the control scheduling information, the electronic device 300 may proceed to operation 815 and generate topology information between a plurality of external electronic devices and update the topology based on acquired measurement information. The external electronic device 400 according to an embodiment may repeatedly perform some of operations 821 to 829 until the electronic device 300 generates topology information between the plurality of external electronic devices through operation 815 and updates the topology.

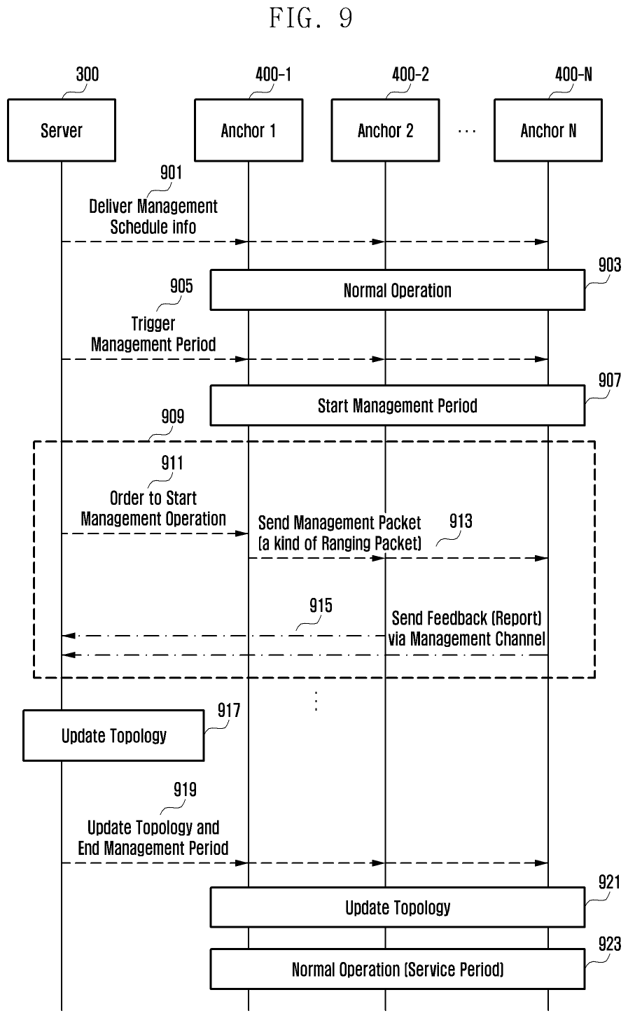

FIG. 9 is a signal flow diagram illustrating example management for a network including a plurality of external electronic devices (e.g., external electronic devices 220, 230, 240 and/or 250 of FIG. 2, the external electronic device 400 of FIG. 4, or a plurality of anchors 400-1, 400-2, . . . , 400-N of FIG. 5) by an electronic device (e.g., the electronic device 210 of FIG. 2 or the electronic device 300 of FIG. 3 or FIG. 5) according to various embodiments.

According to various embodiments, in operation 901, the electronic device 300 may deliver management schedule information to a plurality of external electronic devices (400-1 . . . 400-N).

According to various embodiments, in operation 903, a normal operation (e.g., a positioning service) may be performed between a plurality of external electronic devices. According to various embodiments, the server 300 may trigger the management period in operation 905. For example, the electronic device 300 may trigger the management period periodically or based on a request from the electronic device 300. According to various embodiments, the management period may start in operation 907.

According to various embodiments, the electronic device 300 may control each of the plurality of external electronic devices to start the management operation 909 during the management period, as illustrated in operation 911. To this end, the electronic device 300 may transmit signals to the plurality of external electronic devices in a broadcast or unicast manner. It is described that the signal transmission of the operation 911 for the management operation 909 for each of the plurality of external electronic devices by the electronic device 300 is performed for each of the plurality of external electronic devices, but the disclosure is not limited thereto. For example, when delivering management schedule information for the plurality of external electronic devices in operation 901, it may also be implemented to deliver management operation trigger time information for each external electronic device, such as a scheduling index, in advance.

According to an embodiments, in operation 913, the external electronic device (e.g., the anchor 1 400-1) may transmit a management packet (e.g., a kind of ranging packet) as a signal. According to an embodiment, in operation 915, external electronic devices (e.g., the anchor 2 400-2 to anchor N 400-N) may transmit feedback information including measurement information to the electronic device 300 through a management channel. For example, each external electronic device may transmit a feedback signal including measurement information to the electronic device 300, for example, in a unicast manner, when each measurement information is acquired. The management channel may be configured using, for example, a wireless communication channel such as Wi-Fi or cellular communication.

According to various embodiments, in operation 917, the electronic device 300 may identify that the transmission of management packets to all external electronic devices and the corresponding measurement information feedback have been terminated, and may generate (or update) topology information between external electronic devices based on the acquired measurement information. According to various embodiments, in operation 919, the electronic device 300 may transmit the updated topology information to external electronic devices and terminate the management period.

According to various embodiments, in operation 921, the external electronic devices that have received updated topology information may update the topology of the cluster. According to various embodiments, the external electronic devices may provide a positioning service according to a normal operation based on the updated cluster topology in operation 923.

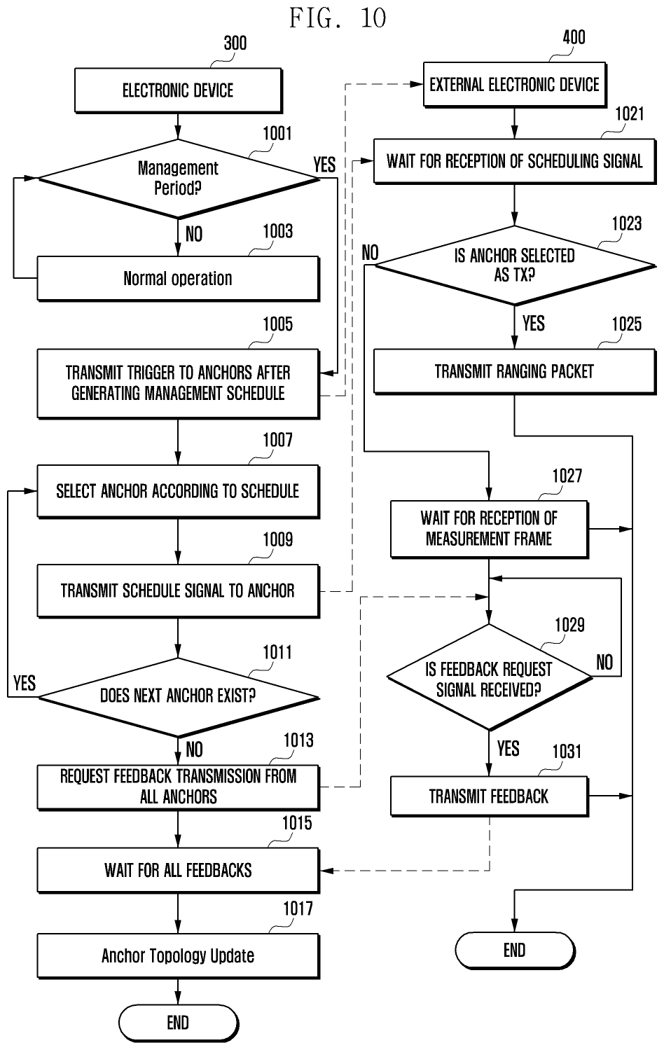

FIG. 10 is a flowchart illustrating an example control operation for managing a network including a plurality of external electronic devices by an electronic device according to various embodiments.

FIG. 10 is a flowchart illustrating example management of a network including a plurality of external electronic devices (e.g., external electronic devices 220, 230, 240 and/or 250 of FIG. 2, the external electronic device 400 of FIG. 4, or a plurality of anchors 400-1, 400-2, . . . , 400-N of FIG. 5) by an electronic device (e.g., the electronic device 210 of FIG. 2 or the electronic device 300 of FIG. 3 or FIG. 5) according to various embodiments.

According to various embodiments, in operation 1001, the electronic device 300 may identify whether a management period has arrived. The management period may be configured periodically in advance or triggered when necessary by the electronic device 300.

According to various embodiments, if it is identified that the management period has not arrived, the electronic device 300 may proceed to operation 1003 and control a plurality of external electronic devices to provide a positioning service according to a normal operation in the normal operation period.

According to various embodiments, if it is identified that the management period has arrived, the electronic device 300 may proceed to operation 1005 to generate management schedule information and transmit a trigger of the management period to a plurality of external electronic devices.

According to various embodiments, when the management period is triggered, the electronic device 300 may select one of a plurality of external electronic devices according to the control scheduling information in operation 1007. According to various embodiments, the electronic device 300 may transmit a scheduling signal including schedule information for control to one external electronic device selected in operation 1009.

According to various embodiments, in operation 1021, the external electronic device 400 that has received the trigger for the management period according to operation 1005 from the electronic device 300 may wait for reception of a scheduling signal from the electronic device 300.

According to various embodiments, in operation 1023, the external electronic device 400 may receive the scheduling signal and identify whether the external electronic device 400 is the anchor selected as the transmission device.

According to various embodiments, in operation 1025, the external electronic device 400 may transmit a ranging packet signal when it is identified that the external electronic device 400 is the anchor selected as the transmission device.

According to various embodiments, in operation 1011, the electronic device 300 may identify whether an external electronic device of the next order exists based on the control scheduling information. According to various embodiments, when an external electronic device of the next order exists based on the control scheduling information, the electronic device 300 may return to operation 1007 and select an external electronic device of the next order according to the control scheduling.

According to various embodiments, when it is identified that an external electronic device of the next order does not exist based on the control scheduling information in operation 1011, the electronic device 300 may request feedback transmission of measurement information for all external electronic devices in operation 1013.

According to various embodiments, if it is identified that the external electronic device 400 is not the anchor selected as the transmission device, the external electronic device 400 may proceed to operation 1027 and wait for reception of a measurement frame including measurement information transmitted from another external electronic device.

According to various embodiments, the external electronic device 400 may proceed to operation 1029 and identify whether a feedback request signal has been received. According to various embodiments, when receiving the feedback request signal, the external electronic device 400 may proceed to operation 1031 and transmit the feedback signal to the electronic device 300.

According to various embodiments, in operation 1015, the electronic device 300 may wait for receiving a feedback signal. For example, the electronic device 300 may wait until receiving feedback signals from all external electronic devices. According to various embodiments, in operation 1017, the electronic device 300 may generate topology information between a plurality of external electronic devices based on the measurement information acquired from the feedback signal and update the topology.

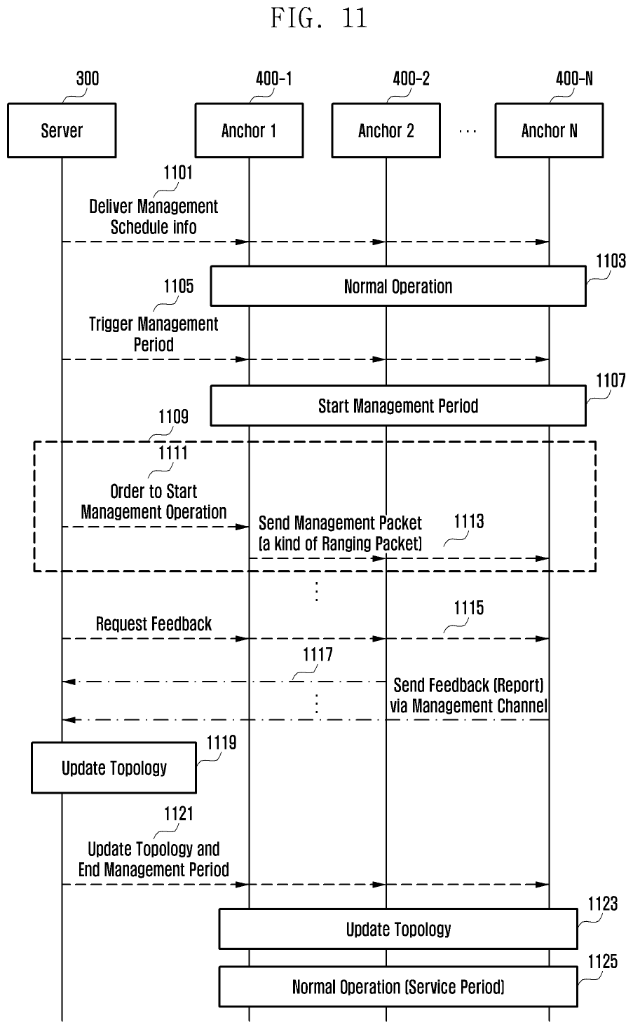

FIG. 11 is a signal flow diagram illustrating example management for a network including a plurality of external electronic devices (e.g., external electronic devices 220, 230, 240 and/or 250 of FIG. 2, the external electronic device 400 of FIG. 4, or a plurality of anchors 400-1, 400-2, . . . , 400-N of FIG. 5) by an electronic device (e.g., the electronic device 210 of FIG. 2 or the electronic device 300 of FIG. 3 or FIG. 5) according to various embodiments.

According to various embodiments, in operation 1101, the electronic device 300 may deliver management schedule information to a plurality of external electronic devices.

According to various embodiments, in operation 1103, a normal operation (e.g., a positioning service) may be performed between a plurality of external electronic devices. According to various embodiments, the server 300 may trigger the management period in operation 1105. For example, the electronic device 300 may trigger the management period periodically or based on a request from the electronic device 300. According to various embodiments, the management period may start in operation 1107.

According to various embodiments, the electronic device 300 may control each of the plurality of external electronic devices to start the management operation 1109 during the management period, as illustrated in operation 1111. To this end, the electronic device 300 may transmit signals to the plurality of external electronic devices in a broadcast or unicast manner. It is described that the signal transmission of the operation 1111 for the management operation 1109 for each of the plurality of external electronic devices by the electronic device 300 is performed for each of the plurality of external electronic devices, but the disclosure is not limited thereto. For example, when delivering management schedule information for the plurality of external electronic devices in operation 901, it may also be implemented to deliver management operation trigger time information for each external electronic device, such as a scheduling index, in advance.

According to various embodiments, in operation 1113, the external electronic device (e.g., the anchor 1 400-1) may transmit a management packet (e.g., a kind of ranging packet) as a signal.

According to various embodiments, during the management period, the electronic device 300 may terminate the transmission of the ranging packet signal and the acquisition of the measurement information of all external electronic devices such as operation 1113, according to the control for all of the external electronic devices as illustrated in operation 1111. According to various embodiments, in operation 1115, the electronic device 300 may request feedback on the measurement information acquired by a plurality of external electronic devices.

According to various embodiments, in operation 1117, the plurality of external electronic devices may transmit feedback information including measurement information to the electronic device 300 through the management channel according to the feedback request from the electronic device 300.

According to various embodiments, in operation 1119, the electronic device 300 may identify that the feedback of measurement information according to feedback requests to all external electronic devices has been terminated, and may generate (or update) topology information between external electronic devices based on the acquired measurement information. According to various embodiments, in operation 1121, the electronic device 300 may transmit the updated topology information to external electronic devices and terminate the management period.

According to various embodiments, in operation 1123, the external electronic devices that have received updated topology information may update the topology of the cluster. According to various embodiments, the external electronic devices may provide a positioning service according to a normal operation based on the updated cluster topology in operation 1125.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a wireless communication circuit;
memory; and
at least one processor, comprising processing circuitry, operatively connected to the wireless communication circuit and the memory,
wherein the memory storing instructions for generating management information for managing a plurality of anchors, and
wherein the instructions which, when executed by the at least one processor individually and/or collectively, cause the electronic device to:
identify a control scheduling for the plurality of anchors;
control a ranging signal transmission by the plurality of anchors to be sequentially performed through the wireless communication circuit based on the control scheduling;
receive, from the plurality of anchors, a feedback signal according to the ranging signal transmission; and
update a topology for the plurality of anchors based on the feedback signal.

2. The electronic device of claim 1,
wherein the instructions which, when executed by the at least one processor individually and/or collectively, cause the electronic device to receive each of the feedback signals according to the ranging signal transmission by each of the plurality of anchors.

3. The electronic device of claim 1,
wherein the instructions which, when executed by the at least one processor individually and/or collectively, cause the electronic device to:
transmit the feedback request signal to the plurality of anchors based on the ranging signal transmission by the plurality of anchors being terminated; and
receive the feedback signals of the plurality of anchors in response to the feedback request signal.

4. The electronic device of claim 1,
wherein the instructions which, when executed by the at least one processor individually and/or collectively, cause the electronic device to:
trigger a management period for controlling the plurality of anchors according to the control scheduling; and
control the ranging signal transmission by the plurality of anchors by transmitting a control signal to each of the plurality of anchors based on the control scheduling during the management period.

5. The electronic device of claim 4,
wherein the instructions which, when executed by the at least one processor individually and/or collectively, cause the electronic device to trigger the management period according to the control scheduling after termination of the normal operation period providing a positioning service by transmitting and receiving signals by the plurality of anchors.

6. The electronic device of claim 1,
wherein the instructions which, when executed by the at least one processor individually and/or collectively, cause the electronic device to update the topology for the plurality of anchors based on measurement information included in the feedback signal.

7. The electronic device of claim 6,
wherein the measurement information includes at least one of the received signal strength indicator (RSSI), signal to noise ratio (SNR), line-of-sight (LoS) measurement, or actual distance between the plurality of anchors.

8. The electronic device of claim 7,
wherein the instructions which, when executed by the at least one processor individually and/or collectively, cause the electronic device to generate a proximity graph between the plurality of anchors based on the measurement information.

9. The electronic device of claim 8,
wherein the instructions which, when executed by the at least one processor individually and/or collectively, cause the electronic device to generate the proximity graph by combining a matrix having a line-of-sight (LoS) measurement between the plurality of anchors as an element and a matrix having at least one of the received signal strength indicator (RSSI), signal-to-noise ratio (SNR), or actual distance between the plurality of anchors as an element.

10. The electronic device of claim 8,
wherein the instructions which, when executed by the at least one processor individually and/or collectively, cause the electronic device to update the topology by connecting each vertex corresponding to the plurality of anchors with an edge based on an element of the proximity graph.

11. A method performed by an electronic device, the method comprising:
identifying a control scheduling for a plurality of anchors to generate management information for managing the plurality of anchors;
controlling a ranging signal transmission by the plurality of anchors to be performed respectively through the wireless communication circuit based on the control scheduling;
receiving, from the plurality of anchors, a feedback signal according to the ranging signal transmission; and
updating a topology for the plurality of anchors based on the feedback signal.

12. The method of claim 11, further comprising triggering a management period for controlling the plurality of anchors according to the control scheduling,
wherein the controlling includes controlling the ranging signal transmission by the plurality of anchors by transmitting a control signal to each of the plurality of anchors based on the control scheduling during the management period.

13. The method of claim 12, wherein the triggering includes triggering the management period according to the control scheduling after termination of the normal operation period providing a positioning service by transmitting and receiving signals by the plurality of anchors.

14. The method of claim 11,
wherein the updating includes updating the topology for the plurality of anchors based on measurement information included in the feedback signal.

15. The method of claim 14, wherein the measurement information includes at least one of the received signal strength indicator (RSSI), signal to noise ratio (SNR), line-of-sight (LoS) measurement, or actual distance between the plurality of anchors.

16. The method of claim 15, further comprising generating a proximity graph between the plurality of anchors based on the measurement information,
wherein generating the proximity graph includes combining a matrix having a line-of-sight (LoS) measurement between the plurality of anchors as an element and a matrix having at least one of the received signal strength indicator (RSSI), signal-to-noise ratio (SNR), or actual distance between the plurality of anchors as an element.

17. The method of claim 11, wherein the receiving includes receiving each of the feedback signals according to the ranging signal transmission by each of the plurality of anchors.

18. The method of claim 11, further comprising transmitting the feedback request signal to the plurality of anchors based on the ranging signal transmission by the plurality of anchors being terminated,
wherein the receiving includes receiving the feedback signals of the plurality of anchors in response to the feedback request signal.

19. A non-transitory computer-readable storage medium for storing one or more programs comprising computer-executable instructions that, when individually or collectively executed by at least one processor of an electronic device, cause the electronic device to:
identify a control scheduling for the plurality of anchors;
control a ranging signal transmission by the plurality of anchors to be sequentially performed through the wireless communication circuit based on the control scheduling;
receive, from the plurality of anchors, a feedback signal according to the ranging signal transmission; and
update a topology for the plurality of anchors based on the feedback signal.

20. The non-transitory computer-readable storage medium of claim 19, wherein the one or more programs comprising computer-executable instructions that, when individually or collectively executed by at least one processor of an electronic device, cause the electronic device to:
trigger a management period for controlling the plurality of anchors according to the control scheduling; and
control the ranging signal transmission by the plurality of anchors by transmitting a control signal to each of the plurality of anchors based on the control scheduling during the management period.
